(19) United States
(12) Patent Application Publication
(10) Pub. No.: US 2026/0254639 A1
(43) Pub. Date: Aug. 27, 2026

(54) LLM PROTECTION THROUGH END-TO-END CRYPTO BROADCASING PROTOCOLS

(71) Applicant: Lenovo (United States) Inc., Morrisville, NC (US)

(72) Inventors: Christian De Hoyos, Morrisville, NC (US); Igor Stolbikov, Morrisville, NC (US); Scott Li, Morrisville, NC (US); Joshua N. Novak, Morrisville, NC (US); Scott Kelso, Morrisville, NC (US)

(21) Appl. No.: 19/062,268

(22) Filed: Feb. 25, 2025

(51) Int. Cl. H04L 9/30; H04L 9/08

(52) U.S. Cl. CPC H04L 9/3066; H04L 9/0869

(57) ABSTRACT

In one aspect, a system is implemented for large language model (LLM) protection through end-to-end cryptography broadcasting protocols. The system uses an elliptic-curve cryptography (ECC) broadcast schema and post-quantum module lattice-based key encapsulation mechanism (ML-KEM) encapsulation for LLM file distribution. The system can include one or both of the client device(s) and cloud-based server(s) that communicate with each other for download of the LLM files to the client device(s).

### FIELD

The disclosure below relates to technically inventive, non-routine solutions that are necessarily rooted in computer technology and that produce concrete technical improvements. In particular, the disclosure below relates to large language model (LLM) protection through end-to-end cryptographic broadcasting protocols.

### BACKGROUND

As recognized herein, current networking technology is insufficient for efficiently and securely distributing large language models (LLMs) and other AI models for storage within local area networks, particularly in light of advances in quantum computing.

### SUMMARY

Accordingly, in one aspect an apparatus includes a processor system and storage accessible to the processor system. The storage includes instructions executable by the processor system to send, from a first device to a second device, a request related to acquisition of a large language model (LLM) or other generative pretrained transformer (GPT). The instructions are also executable to send, from the first device to the second device, a device identifier (ID) and an LLM protection key. The LLM protection key as sent to the second device is encapsulated with a public module lattice-based key encapsulation mechanism (ML-KEM) key associated with the second device. In response to the request, the instructions are executable to receive, from the second device, a signed uniform resource locator (URL) and encryption header data for decrypting files related to the LLM. The instructions are then executable to download the files related to the LLM to the first device from a location accessible via the signed URL. The instructions are also executable to receive a command to access the LLM and, responsive to receipt of the command, use the encryption header data to decrypt the files related to the LLM.

In some example embodiments, the instructions may be executable to use an upload protection key indicated via the encryption header data to decrypt the files related to the LLM. If desired, the upload protection key may be a master key. Additionally, in certain specific instances, the instructions may be executable to determine the upload protection key using a private ML-KEM key associated with the first device and using a private elliptic-curve cryptography (ECC) key associated with the first device.

Also in certain example embodiments, the instructions may be executable to encapsulate the LLM protection key with the public ML-KEM key associated with the second device. If desired, the LLM protection key may be a 256-bit key.

What's more, in some instances the instructions may be executable to, prior to sending the request, generate the LLM protection key itself. In one specific example, the LLM protection key may be generated as a secure random value.

Still further, in some example embodiments the apparatus may include the first device, which itself may include one or more client devices. Additionally or alternatively, the apparatus may include the second device, which itself may include one or more servers.

In another aspect, a method includes receiving, from a first device and at a second device, a request related to acquisition of a large language model (LLM). The method also includes receiving, from the first device and at the second device, a device identifier (ID) and an LLM protection key. The method then includes encrypting an access key using a private elliptic-curve cryptography (ECC) key associated with the second device, with the access key being usable to decrypt the files related to the LLM. The method further includes encapsulating the encrypted access key using a public module lattice-based key encapsulation mechanism (ML-KEM) key associated with the first device. In response to receiving the request, the method then includes sending, from the second device to the first device, both a uniform resource locator (URL) for downloading the files related to the LLM and the encapsulated, encrypted access key.

In certain example instances, the encapsulated, encrypted access key may be indicated as part of encryption header data.

Also in certain example instances, the method may include decapsulating the LLM protection key using a private ML-KEM key associated with the second device.

In still another aspect, an apparatus includes at least one computer readable storage medium (CRSM) that is not a transitory signal. The at least one CRSM includes instructions executable by a processor system to use an elliptic-curve cryptography (ECC) broadcast schema and post-quantum module lattice-based key encapsulation mechanism (ML-KEM) encapsulation for file distribution.

In certain example embodiments, the file distribution may relate to large language model (LLM) distribution.

Also in certain example embodiments, the instructions may be executable to send, from a first device to a second device, a request related to acquisition of a large language model (LLM). Here, the instructions may be further executable to send, from the first device to the second device, a device identifier (ID) and an LLM protection key. The LLM protection key as sent to the second device may be encapsulated with a public ML-KEM key associated with the second device. The instructions may also be executable to, in response to the request, receive, from the second device, a signed uniform resource locator (URL) and encryption header data for decrypting files related to the LLM. The instructions may be further executable to download the files related to the LLM to the first device from a location accessible via the signed URL and to use the encryption header data to decrypt the files related to the LLM. In some specific examples, the instructions may also be executable to receive a command to access the LLM and then use the encryption header data to decrypt the files related to the LLM responsive to receipt of the command. If desired, the instructions may be further executable to use an upload protection key indicated via the encryption header data to decrypt the files related to the LLM, and to determine the upload protection key using a private ML-KEM key associated with the first device and using a private ECC key associated with the first device. The apparatus may even include the first device.

In addition to or in lieu of the foregoing, the instructions may be executable to receive, from a first device and at a second device, a request related to acquisition of a large language model (LLM). Here the instructions may be executable to receive, from the first device and at the second device, a device identifier (ID) and an LLM protection key. The instructions may then be executable to encrypt an access key using a private ECC key associated with the second device, where the access key may be usable to decrypt the files related to the LLM. The instructions may then be executable to encapsulate the encrypted access key using a public ML-KEM key associated with the first device. In response to receiving the request, the instructions may be executable to send, from the second device to the first device, both a uniform resource locator (URL) for downloading the files related to the LLM and the encapsulated, encrypted access key. If desired, in certain instances the instructions may be further executable to decapsulate the LLM protection key using a private ML-KEM key associated with the second device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIG. 2 is a block diagram of an example network of devices consistent with present principles;

FIG. 3 shows example client-side setup logic in flow chart format consistent with present principles;

FIG. 4 shows example server-side setup logic in flow chart format consistent with present principles;

FIG. 5 shows a schematic diagram of a client device and cloud server communicating for secure LLM access consistent with present principles;

FIG. 6 shows example client-side deployment logic in flow chart format consistent with present principles; and

FIG. 7 shows example server-side deployment logic in flow chart format consistent with present principles.

### DETAILED DESCRIPTION

Among other things, the detailed description below deals with secure large language model (LLM) distribution and device locking. Consistent with aspects discussed below, artificial intelligence (AI)-based computing systems may be implemented for LLM files to be distributed to local machines and provide important user assistance. Present principles recognize that the LLMs should be protected end-to-end during transmission to prevent unauthorized access and tampering, and that the protection should be resilient to quantum-based attacks in a post-quantum computing environment.

Accordingly, principles set forth in greater detail below provide an innovative end-to-end cryptographic broadcasting protocol for large file distribution, including for LLM distribution and other large-model distribution. This may help ensure that transmitted data (e.g., LLMs) remains encrypted throughout its entire journey, from the point of origin to the final destination where it is used. This protocol provides the ability to distribute LLM files efficiently without the need for re-encryption for each individual end-user. This, in turn, reduces computational overhead, results in faster distribution times, provides scalability for large user bases, and lowers operational costs for the distributor.

In terms of the cloud, cloud storage protection is also encompassed by present principles, with files remaining encrypted all the time in the client and cloud storage areas with the group master encryption key. The process can advantageously involve key management services tied to LLM cloud storage, while also providing just-in-time decryption. For instance, the protocol may implement a just-in-time decryption mechanism so that files are only decrypted when their content needs to be loaded into memory (e.g.,, RAM) for processing. The local security chip on each client device may provide additional protection for the keys and encrypted files.

Additionally, in implementing the protocols discussed below, key independence may be facilitated so that keys are calculated independent from each other. The compromise of the keys for some devices may therefore not lead to the compromise of keys for other devices. Present principles also provide for dynamically adding new devices to LLM distribution, as well as scalability for efficient LLM distribution processes (in addition to providing secure distribution), which is helpful when transmitting LLM files that are relatively large in size and are not typically unique per device. Present principles further provide identify-based management, with each receiver (client) having a unique secure identity combined with device public keys, while also providing security in that only intended recipients may be permitted to receive encrypted files (LLM or otherwise) and also in that chosen cipher text attack (CCA) instances may be reduced.

As also discussed herein, present principles may encompass distributor (cloud) authentication, where authentication functions on the distributor may be provided for the broadcaster to provide keys that allow the receivers to verify authenticity. In some instances, a malicious attacker may therefore be prevented from pretending to be a legitimate party to distribute LLM files.

Also of note is that the protocols set forth below may be more quantum-safe, providing secure communication methods in the age of quantum compute risks.

Accordingly, in one non-limiting example implementation, a setup process may be undertaken at the client device and server. Here, the client device may provide, to the cloud, the client device's public ECC key and public ML-KEM key. At the server, the keys may be stored securely and linked to the client device's secure device ID. The client device may also store security private keys in its security chip, with the client device having the distribution server's public ECC key and public ML-KEM key.

Then for LLM access during deployment, the client device may request the LLM or other model. The client device may provide the following according to this example request: deviceID, and LLM protection key (256 bit) encapsulated with the cloud ML-KEM key. The cloud server may then respond with the signed URL for encrypted files download and file access encapsulation. File access encapsulation may allow for decrypting the files after the download is complete and when access to them is requested. Device private ML-KEM keys, ECC keys, and upload protection keys may be required in non-limiting example instances for the client software to decrypt the files.

Also in certain example implementations, in terms of LLM files distribution services, the following steps may be executed:

First, encrypt LLM files with the key derived from the master key (E.g., KDF (master key, file name) using AES256-GCM encryption);

Second, when received a request from the device (“I”) with the following parameters: secure device ID—x; encapsulated LLM Protection key—p

Then execute the following:
(a) Decapsulate p;
(b) Choose a random k, and t;
(c) Compute R=k*B where B is the cloud public key;
(d) Compute Ki=k*Qi where Qi is the device public ECC key;
(e) Encrypt master key with a symmetric cipher derived from Ki, e.g., SHA256 (ECDH (b, Ki), x, t, p) where b is the cloud private ECC key;
(f) Encapsulate t with device ML-KEM key−T;
(g) Broadcast (R, T, {Encrypted master key for each i}); and
(h) Generate signed URL for encrypted files stored in S3.

Also, note that an elliptic curve E may be selected over a finite field Fq.

Point G may be a predefined base point on the curve E.

Next, in terms of device/receiver operations, the client device might take the following steps in non-limiting example implementations:

First, calculate/generate an LLM protection key “p”. This could be a secure random value or a derivative of the known local key (e.g., SHA256 (PKB, time period) where PKB is a device shared key generated to protect the device data).

Second, send request for LLM protection key and device secure ID. The key may be enclosed with the cloud ML-KEM key.

Third, receive a signed URL and encryption header. The header may include an ephemeral public key “R”, key enclosure “T” and encrypted master key.

Fourth, store the related info for LLM file decryption along with the date of the request.

Fifth, for decryption, calculate the following:
(a) Decapsulate t from the enclosure T;
(b) Calculate shared key KI as ECDH (d, R) where di is device private ECC key;
(c) Calculate master key as SHA256 (KI, x, T, p); and
(d) Decrypt the files with the key derived from the master key.

Present principles thus provide an innovative LLM post-quantum crypto protocol for large file distribution and protection that utilizes ECC broadcast schema and module lattice post-quantum ML-KEM encapsulation.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

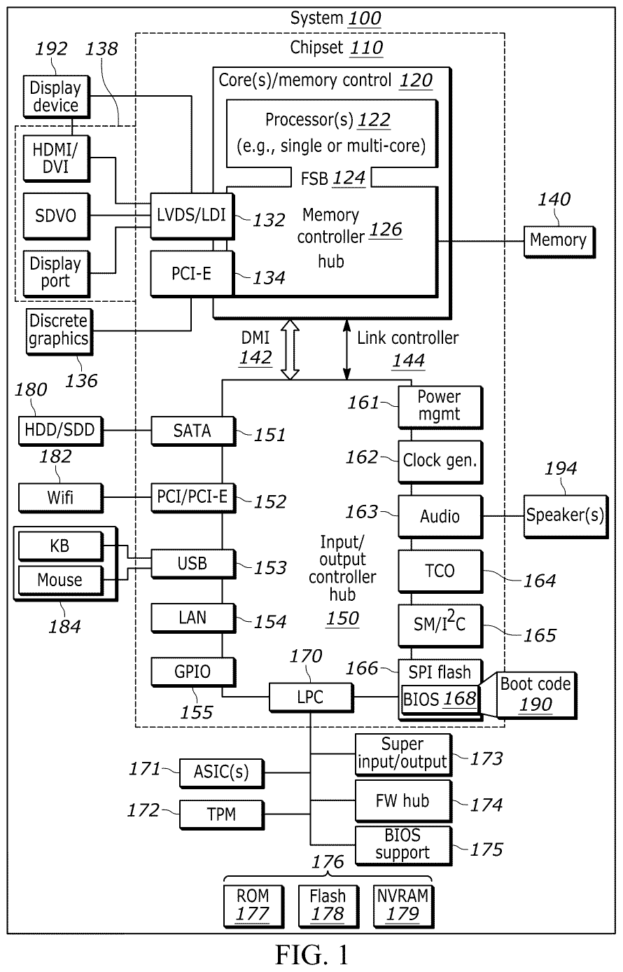

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

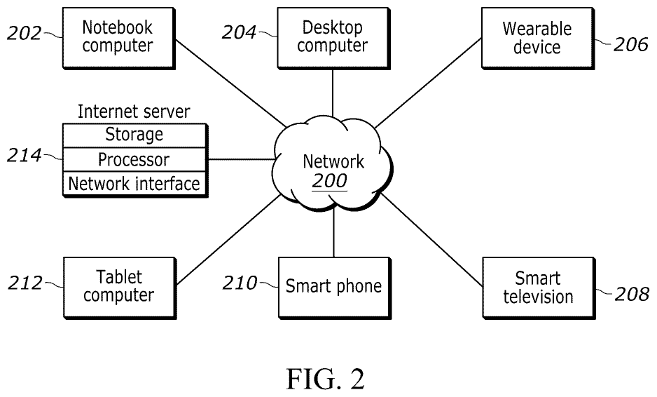

Turning now to FIG. 2, example devices are shown communicating over a network 200 such as the Internet using cryptographic messages consistent with the disclosure below. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208 or other Internet of things (IoT) device, a smart phone 210, a tablet computer 212, and a server 214. The server 214 may include one or more Internet-based cloud servers that may exchange cryptographic messages as well as provide cloud storage at which LLMs (and/or other AI models) may be accessed by the devices 202-212 consistent with the disclosure below. Note that the devices 202-212 may also be on their own local area network (LAN) that is connected to the Internet (e.g., a residential or commercial Wi-Fi network).

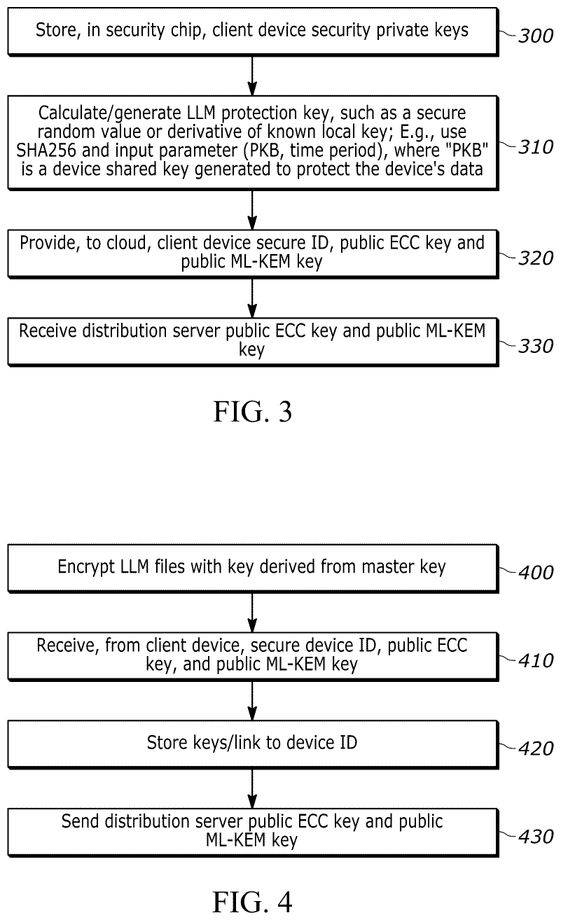

Now in reference to FIGS. 3 and 4 and describing present principles in greater detail, note that first and second devices may communicate with each other using an ECC broadcast schema and post-quantum ML-KEM encapsulation for LLM file distribution and other types of large file distributions. To do so, in some non-limiting instances the first and second devices may initially execute setup logic for subsequent exchange of cryptographic messages during deployment. FIG. 3 therefore shows setup logic for execution by the first device, while FIG. 4 shows setup logic for execution by the second device. The first device may be a client device like a smartphone, laptop computer, smart glasses or other headset, and Internet of things (IoT) device such as a smart doorbell or smart kitchen appliance, and/or another type of client device on a LAN. The second device may be one or more cloud-based servers accessible over the Internet, though other types of devices may also be used including servers on the client device LAN and even other client devices.

With the foregoing in mind, client-side setup logic for the first device will now be described in reference to FIG. 3. Beginning at block 300, at manufacture or another time, the first device may store, in its security chip, client device (security) private keys as discussed below for the first device itself. Note that the security chip may be a trusted platform module (TPM) or other suitable chip.

The logic of FIG. 3 may then proceed to block 310. Here, the first device may, at manufacture or another time prior to deployment operations, calculate or otherwise generate an LLM protection key. The LLM protection key may be a secure random value or a derivative of a known local key. In one particular non-limiting example, the LLM protection key may be a 256-bit key determined via SHA256 (or other suitable cryptographic hash algorithm) with the input parameter (PKB, time period). “PKB” may be a device shared key generated to protect the first device's data.

After block 310 the logic may then proceed to block 320. Here the first device may provide, to the second device (e.g., one or more cloud servers), a client device secure ID, a public ECC key for the first device, and a public ML-KEM key for the first device. The logic may then proceed to block 330 where the first device may receive a public ECC key for the second device (e.g., distribution server) and public ML-KEM key for the second device.

Now in reference to FIG. 4, this flow chart shows reciprocal server-side setup logic that may be executed by the aforementioned second device. Beginning at block 400, the second device may encrypt LLM files to be downloaded by the first device with a key derived from a master decryption key for decrypting the LLM's files. For example, the key may be an upload protection key derived using AES256-GCM encryption with the input parameter KDF (master key, file name).

From block 400 the logic of FIG. 4 may then continue to block 410. Here, the second device may receive, from the first (client) device, the first device's secure device ID, public ECC key, and public ML-KEM key. The logic may then proceed to block 420 where the second device may store, to local persistent storage (e.g., HDD or SSD), the received secure device ID, public ECC key, and public ML-KEM key for the first device. Those items may be linked in cloud storage to the secure device ID for the first device, e.g., using a relational database or data table.

After block 420 the logic may proceed to block 430. At this step, the second device may send its own (distribution server) public ECC key and public ML-KEM key to the first device.

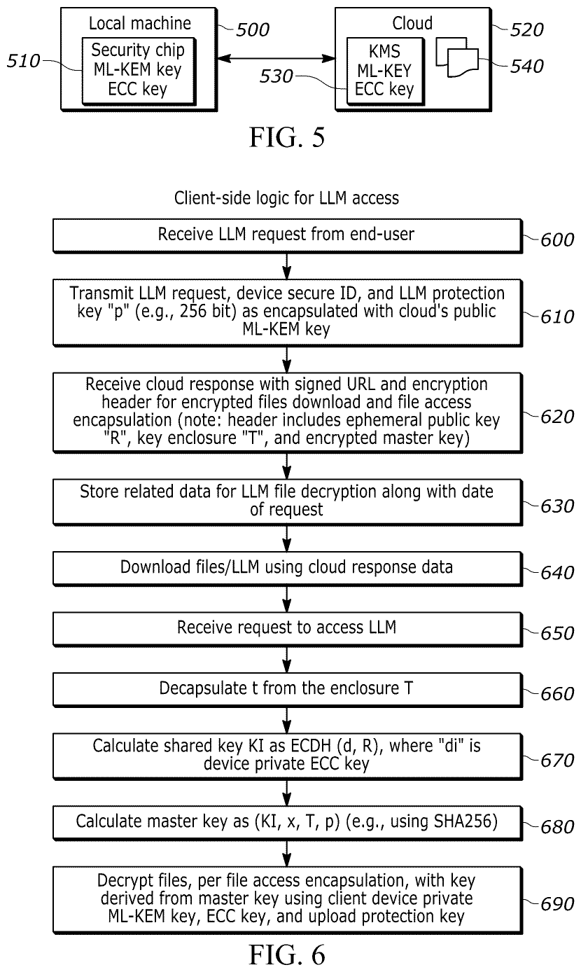

Now in reference to FIG. 5, this figure shows a schematic of the first and second devices communicating with each other consistent with present principles. As shown, the first device has been designated as element 500 and may include a security chip 510 (e.g., TPM) that securely stores the first device's own private ML-KEM key and private ECC key. Though not shown, further note that the first device may also store the second device's public ECC key and public ML-KEM key when received, though not necessarily in the security chip 510 to prevent the chip 510 from being compromised in a post-manufacturing write operation.

As also shown, the second device has been designated as element 520 and may include its own secure storage 530, such as a key management system (KMS). The secure storage 530 may securely store the second device's own private ML-KEM key and private ECC key.

Also note that though not shown, the second device may also store the first device's secure device ID, public ECC key, and public ML-KEM key when received as described above. What's more, the second device 520 may also store one or more LLMs 540, individual LLM files, and/or other AI models and files that may be distributed to client devices using the cryptographic advances set forth herein.

With the foregoing setup algorithms being executed and the foregoing keys being stored at each device as described above, the first and second devices may then be used during deployment for LLM file distribution. Beginning first with the client-side deployment logic of FIG. 6 as executable by the first device (client device) for gaining LLM access, at block 600 the first device may receive an LLM request from its end-user as entered using a keyboard, cursor, voice input, etc.

From block 600 the logic may then proceed to block 610. Here, the first device may, in response to the user input, send a request to the second device to acquire an LLM indicated in the user input. Also at block 610, the device may, in response to the user input, send its secure device ID “x” and its LLM protection key “p” as generated at step 310 above (e.g., via SHA256). Also note that the LLM protection key as sent to the second device may be encapsulated by the first device with the public ML-KEM key of the second (cloud) device as previously received and stored at step 330 above.

The logic may then continue to block 620. Here, the second device may, in response to the request, receive a response from the second device. The response may indicate a signed uniform resource locator (URL) and encryption header data for decrypting encrypted files related to the LLM (e.g., as downloaded from the second device or other cloud-based LLM source). The encryption header data may also be used for file access encapsulation. In one particular example, the header data may include an ephemeral public key “R”, a key enclosure “T”, and an encrypted master key for accessing the LLM being requested.

After executing block 620, the logic may then proceed to block 630. At this step, the first device may store the data received at block 620 for LLM file decryption, along with storing the date of the request. The logic may then proceed to block 640 where the first device may use the signed URL to navigate over the Internet to a website (or other location accessible via the signed URL) at which the first device can download the files related to the LLM to the first device itself (e.g., download a copy of the LLM).

After block 640 the logic may proceed to block 650. Here, the first device may receive a command to access the LLM, such as a user command to launch the LLM as downloaded and installed at the first device itself. Responsive to receipt of the command, the first device may then use the encryption header data to decrypt the files related to the LLM. Thus, in some example non-limiting embodiments, the LLM may remain stored at the first device in encrypted form, and only be decrypted when the LLM is requested by the end-user. This may help reduce opportunity for nefarious third parties to gain unauthorized access to the first device's local copy of the LLM.

Steps 660-690 then go into greater detail about LLM decryption at the first device. Specifically, at step 660 the first device may decapsulate “t” from the enclosure “T” referenced above. Then at block 670 the first device may calculate a shared key “KI” as elliptic-curve Diffie-Hellman (ECDH) (d, R), where “di” is the first device's private ECC key. The logic may then proceed to block 680 where the first device may calculate an access key, such as an LLM master key, as (KI, x, T, p) using SHA256 or another cryptographic hash algorithm. Then at block 690, the first device may decrypt the LLM files, per file access encapsulation, with the upload protection key derived from the access (e.g., master) key using each of the first device's private ML-KEM key, the first device's private ECC key, and the access key itself.

Thus, it is to be understood that in one non-limiting example, the first device may use the upload protection key as indicated in encapsulated/encrypted form via the encryption header data to then decrypt the files related to the LLM using the upload protection key.

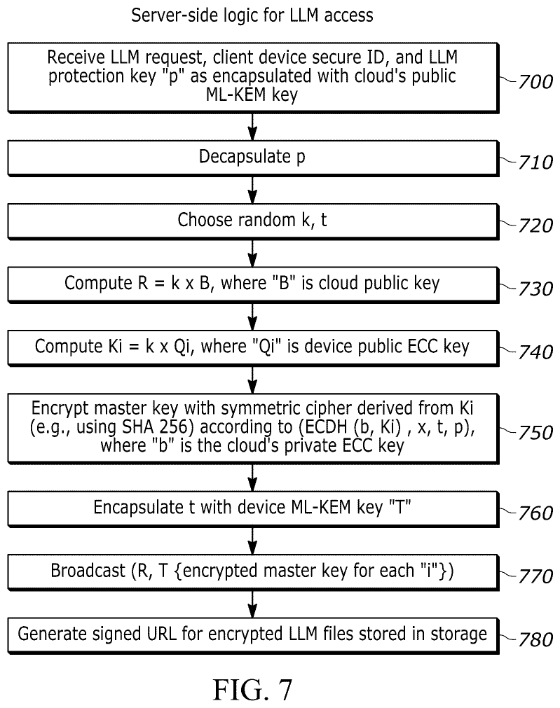

Continuing the detailed description in reference to the server-side deployment logic of FIG. 7, again note that this logic may be executed by the second device referenced above, which itself may include one or more cloud-based servers. Beginning at block 700, the second device may receive a request related to acquisition of an LLM (e.g., LLM request from the first device as sent at block 610). Also at block 700, the second device may receive a secure device ID for the first device and the LLM protection key “p” as encapsulated with second device's public ML-KEM key (again with the LLM protection key itself being generated at and sent from the first device).

Thus, at block 710 the second device may decapsulate the LLM protection key using the second device's private ML-KEM key. Then at block 720 the second device may choose/select a random integer “k” and a random integer “t”. The logic may then proceed to block 730 where the second device may compute R=k×B, where “B” is a public key associated with the second device. The logic may then proceed to block 740 where the second device may compute Ki=k×Qi, where “Qi” is a public ECC key associated with the first device (e.g., as received from the first device at block 410).

The logic may then continue on to block 750. Here, the second device may encrypt an LLM access key (e.g., master key) with a symmetric cipher derived from Ki. For example, the LLM access key may be derived using SHA256 (or other suitable cryptographic hash algorithm) according to the parameter (ECDH (b, Ki), x, t, p), where “b” is the second device's own private ECC key.

From block 750 the logic may then proceed to block 760. Here, the second device may encapsulate “t” with the first device's public ML-KEM key (as received at block 410) to get “T”. From block 760 the logic may then proceed to block 770 where the second device may broadcast, to one or more client devices, (R, T {encrypted master key for each “i”}). Each “i” may be a different client device, and hence each client device may receive its own individual, unique, encapsulated and encrypted LLM access key.

The logic of FIG. 7 may then proceed to bock 780. At this step, the second device may generate, at the second device, the signed URL for the encrypted LLM files stored in a storage system accessible to the second client device. The URL may therefore be digitally signed with a private network key of the second device for signature validation at the first device using the second device's reciprocal public network key (e.g., prior to the first device navigating to a website associated with the URL to then download the LLM/files). The signed URL and signature validation may therefore be used in non-limiting examples for added security to ensure that only trusted LLMs are downloaded from known sources.

It may now be appreciated that present principles provide for improved digital communication between computing devices for large file distribution while increasing network security and functionality. The disclosed concepts are thus rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. An apparatus, comprising:
a processor system; and
storage accessible to the processor system and comprising instructions executable by the processor system to:
send, from a first device to a second device, a request related to acquisition of a large language model (LLM);
send, from the first device to the second device, a device identifier (ID) and an LLM protection key, the LLM protection key as sent to the second device being encapsulated with a public module lattice-based key encapsulation mechanism (ML-KEM) key associated with the second device;
in response to the request, receive, from the second device, a signed uniform resource locator (URL) and encryption header data for decrypting files related to the LLM;
download the files related to the LLM to the first device from a location accessible via the signed URL;
receive a command to access the LLM; and
responsive to receipt of the command, use the encryption header data to decrypt the files related to the LLM.

2. The apparatus of claim 1, wherein the instructions are executable to:
use an upload protection key indicated via the encryption header data to decrypt the files related to the LLM.

3. The apparatus of claim 2, wherein the upload protection key is a master key.

4. The apparatus of claim 2, wherein the instructions are executable to:
determine the upload protection key using a private ML-KEM key associated with the first device and using a private elliptic-curve cryptography (ECC) key associated with the first device.

5. The apparatus of claim 1, wherein the instructions are executable to:
encapsulate the LLM protection key with the public ML-KEM key associated with the second device.

6. The apparatus of claim 1, wherein the LLM protection key is a 256-bit key.

7. The apparatus of claim 1, wherein the instructions are executable to:
prior to sending the request, generate the LLM protection key.

8. The apparatus of claim 7, wherein the LLM protection key is generated as a secure random value.

9. A method, comprising:
receiving, from a first device and at a second device, a request related to acquisition of a large language model (LLM);
receiving, from the first device and at the second device, a device identifier (ID) and an LLM protection key;
encrypting an access key using a private elliptic-curve cryptography (ECC) key associated with the second device, the access key being usable to decrypt the files related to the LLM;
encapsulating the encrypted access key using a public module lattice-based key encapsulation mechanism (ML-KEM) key associated with the first device; and
in response to receiving the request, sending, from the second device to the first device, both a uniform resource locator (URL) for downloading the files related to the LLM and the encapsulated, encrypted access key.

10. The method of claim 9, wherein the encapsulated, encrypted access key is indicated as part of encryption header data.

11. The method of claim 9, comprising:
decapsulating the LLM protection key using a private ML-KEM key associated with the second device.

12. An apparatus, comprising:
at least one computer readable storage medium (CRSM) that is not a transitory signal, the at least one CRSM comprising instructions executable by a processor system to:
use an elliptic-curve cryptography (ECC) broadcast schema and post-quantum module lattice-based key encapsulation mechanism (ML-KEM) encapsulation for file distribution.

13. The apparatus of claim 12, wherein the file distribution relates to large language model (LLM) distribution.

14. The apparatus of claim 12, wherein the instructions are executable to:
send, from a first device to a second device, a request related to acquisition of a large language model (LLM);
send, from the first device to the second device, a device identifier (ID) and an LLM protection key, the LLM protection key as sent to the second device being encapsulated with a public ML-KEM key associated with the second device;
in response to the request, receive, from the second device, a signed uniform resource locator (URL) and encryption header data for decrypting files related to the LLM;
download the files related to the LLM to the first device from a location accessible via the signed URL; and
use the encryption header data to decrypt the files related to the LLM.

15. The apparatus of claim 14, wherein the instructions are executable to:
use an upload protection key indicated via the encryption header data to decrypt the files related to the LLM.

16. The apparatus of claim 15, wherein the instructions are executable to:
determine the upload protection key using a private ML-KEM key associated with the first device and using a private ECC key associated with the first device.

17. The apparatus of claim 14, comprising the first device.

18. The apparatus of claim 14, wherein the instructions are executable to:
receive a command to access the LLM; and
responsive to receipt of the command, use the encryption header data to decrypt the files related to the LLM.

19. The apparatus of claim 12, wherein the instructions are executable to:
receive, from a first device and at a second device, a request related to acquisition of a large language model (LLM);
receive, from the first device and at the second device, a device identifier (ID) and an LLM protection key;
encrypt an access key using a private ECC key associated with the second device, the access key being usable to decrypt the files related to the LLM;
encapsulate the encrypted access key using a public ML-KEM key associated with the first device; and
send, from the second device to the first device, both a uniform resource locator (URL) for downloading the files related to the LLM and the encapsulated, encrypted access key.

20. The apparatus of claim 19, wherein the instructions are executable to:
decapsulate the LLM protection key using a private ML-KEM key associated with the second device.
